(19) United States
(12) Patent Application Publication
(10) Pub. No.: US 2025/0302270 A1
(43) Pub. Date: Oct. 2, 2025

(54) METHOD FOR NOTIFYING RISK OF DOOR COLLISION AND DISHWASHER USING SAME

(71) Applicant: SAMSUNG ELECTRONICS CO., LTD., Suwon-si (KR)

(72) Inventors: Kyungmin KIM, Suwon-si (KR); Jaehee SHIN, Suwon-si (KR); Hwan CHANG, Suwon-si (KR)

(73) Assignee: SAMSUNG ELECTRONICS CO., LTD., Suwon-si (KR)

(21) Appl. No.: 19/236,395

(22) Filed: Jun. 12, 2025

Related U.S. Application Data
(63) Continuation of application No. PCT/KR2024/000025, filed on Jan. 2, 2024.

(30) Foreign Application Priority Data
Jan. 3, 2023 (KR) 10-2023-0000898

(51) Int. Cl. A47L 15/00

(52) U.S. Cl. CPC A47L 15/0049; A47L 2401/26; A47L 2401/34; A47L 2501/26

(57) ABSTRACT

A method of controlling a dishwasher, and a dishwasher. The dishwasher includes a proximity sensor, an output module, at least one memory to store one or more instructions, and at least one processor configured to execute the one or more instructions stored in the memory to determine whether a user is detected in a vicinity of the dishwasher through the proximity sensor, based on whether a door that opens and closes a washing space of the dishwasher is open, and control, through the output module, based on the user being detected, a notification that the door of the dishwasher is open to be output.

### CROSS-REFERENCE TO RELATED APPLICATION(S)

This application is a continuation application, claiming priority under § 111 (a), of International Application No. PCT/KR2024/000025, filed on Jan. 2, 2024, which is based on and claims the benefit of Korean Patent Application No.: 10-2023-0000898, filed Jan. 3, 2023, in the Korean Intellectual Property Office, the disclosures of which are incorporated by reference herein in their entireties.

### TECHNICAL FIELD

The present disclosure relates to a dishwasher capable of notifying about a door collision risk, a method of controlling a dishwasher, and a computer-readable recording medium having stored therein a computer program for executing the method of controlling a dishwasher.

### BACKGROUND ART

Dishwashers are machines for automatically washing and drying dishes. A dishwasher may spray, via a nozzle, washing water onto dishes placed on a washing rack to wash the dishes, and then discharge the washing water through a drain passage. In addition, when the washing operation is complete, the dishwasher may rinse the dishes placed on the washing rack by repeatedly supplying and discharging fresh water through the nozzle. In addition, when the rinsing operation is complete, the dishwasher may dry the dishes by using a heater or residual heat inside the dishwasher.

Recently, consumer concerns about bacterial growth due to residual moisture inside dishwashers after a preset washing and drying cycle is complete have increased. Accordingly, recent dishwashers are equipped with an automatic door opening function that automatically opens the door of the dishwasher after a washing and drying cycle is complete so as to allow the residual moisture to air-dry.

### DISCLOSURE OF INVENTION

### Solution to Problem

An aspect of an embodiment of the present disclosure may provide a dishwasher including a proximity sensor, an output module, at least one memory to store one or more instructions, and at least one processor configured to execute the one or more instructions stored in the memory to determine whether a user is detected in a vicinity of the dishwasher, through the proximity sensor, based on whether a door that opens and closes a washing space of the dishwasher is open, and control, based on the user being detected, a notification that the door of the dishwasher is open to be output through the output module.

An aspect of an embodiment of the present disclosure may provide a method of providing a notification, the method including, based on whether a door that opens and closes a washing space of a dishwasher is open, determining whether a user is detected in the vicinity of the dishwasher, and based on the user being detected, controlling a notification that the door of the dishwasher is open to be output.

An aspect of an embodiment of the present disclosure may provide a computer-readable recording medium having recorded thereon a program for causing a computer to execute the method of providing a notification.

### BRIEF DESCRIPTION OF DRAWINGS

FIG. 1 illustrates a method, performed by a dishwasher, of notifying about a door collision risk, according to an embodiment of the present disclosure.

FIG. 2 illustrates a block diagram of a dishwasher according to an embodiment of the present disclosure.

FIG. 3 illustrates a flowchart of a method, performed by a dishwasher, of notifying about a door collision risk, according to an embodiment of the present disclosure.

FIG. 4 illustrates a method, performed by a dishwasher, of notifying about a door collision risk, based on an opening angle of a door, according to an embodiment of the present disclosure.

FIG. 5 illustrates a method, performed by a dishwasher, of notifying, through a light-emitting module, about a door collision risk, according to an embodiment of the present disclosure.

FIG. 6 is a flowchart of a method, performed by a dishwasher, of notifying about a door collision risk, based on an illuminance, according to an embodiment of the present disclosure.

FIG. 7 illustrates a method, performed by a dishwasher, of notifying about a door collision risk, based on an illuminance, according to an embodiment of the present disclosure.

FIG. 8 is a flowchart of a method, performed by a dishwasher, of controlling a light-emitting module, based on a distance to a user, according to an embodiment of the present disclosure.

FIG. 9 illustrates a method, performed by a dishwasher, of controlling a light-emitting module, based on a distance to a user, according to an embodiment of the present disclosure.

FIG. 10 illustrates a method, performed by a dishwasher, of disabling a proximity sensor according to an installation environment, according to an embodiment of the present disclosure.

FIG. 11 illustrates a block diagram of a dishwasher according to an embodiment of the present disclosure.

### MODE FOR THE INVENTION

As used herein, the expression “at least one of a, b, or c” may indicate only a, only b, only c, both a and b, both a and c, both b and c, all of a, b, and c, or variations thereof.

Hereinafter, embodiments of the present disclosure will be described in detail with reference to the accompanying drawings to enable those of skill in the art to perform the present disclosure without any difficulty. The disclosure may, however, be embodied in many different forms and should not be construed as being limited to an embodiment set forth herein. In addition, in order to clearly describe the present disclosure, portions that are not relevant to the description will be omitted, and similar reference numerals are assigned to similar elements throughout the present specification.

Although the terms used herein are generic terms, which are currently widely used and are selected by taking into consideration functions thereof, the meanings of the terms may vary according to intentions of those of ordinary skill in the art, legal precedents, or the advent of new technology. Thus, the terms should be defined not by simple appellations thereof but based on the meanings thereof and the context of descriptions throughout the present disclosure.

In addition, terms such as ‘first’ or ‘second’ may be used to describe various elements, but the elements should not be limited by the terms. These terms are only used to distinguish one element from another element.

In addition, terms used herein are for describing a particular embodiment, and are not intended to limit the scope of the present disclosure. The singular expression also includes the plural meaning as long as it is not inconsistent with the context. In addition, throughout the present specification, when a part is referred to as being “connected to” another part, it may be “directly connected to” the other part or be “electrically connected to” the other part through an intervening element. In addition, when an element is referred to as “including” a component, the element may additionally include other components rather than excluding other components as long as there is no particular opposing recitation.

As used herein, phrases such as “in some embodiments” or “in an embodiment” does not necessarily indicate the same embodiment.

Embodiments of the present disclosure are to provide a dishwasher capable of providing a door collision risk notification, and a method of controlling the same.

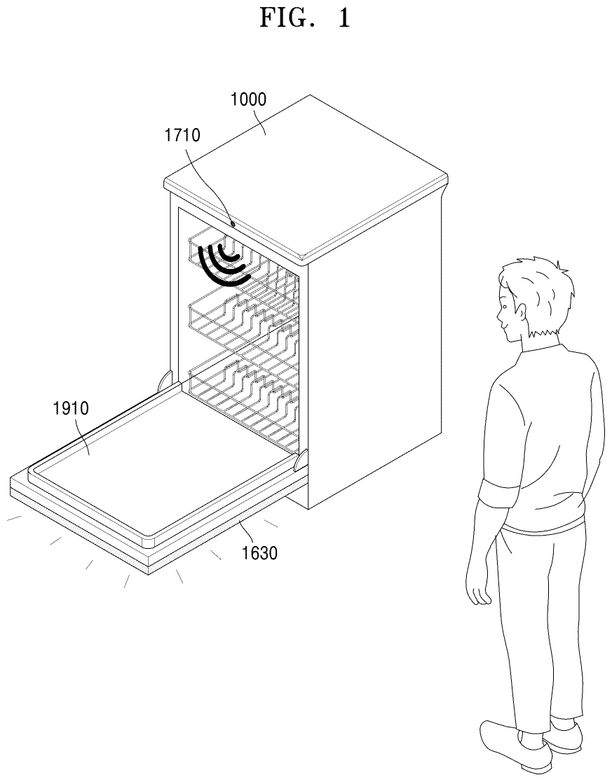

FIG. 1 illustrates a method, performed by a dishwasher, of notifying about a door collision risk, according to an embodiment of the present disclosure.

Referring to FIG. 1, when a door 1910 is open, a dishwasher 1000 may output, based on a user being detected in the vicinity of the dishwasher 1000 by a proximity sensor 1710, a notification that the door 1910 is open.

According to an embodiment, the dishwasher 1000 may activate the proximity sensor when an illuminance outside the dishwasher 1000 is less than or equal to a reference illuminance, and output, when the user is detected in the vicinity of the dishwasher 1000, a notification that the door 1910 is open.

According to an embodiment, the dishwasher 1000 may activate the proximity sensor 1710 when the opening angle of the door 1910 is greater than or equal to a threshold angle, and output, when the user is detected in the vicinity of the dishwasher 1000, a notification that the door 1910 is open.

According to an embodiment, the dishwasher 1000 may activate the proximity sensor 1710 when the illuminance outside the dishwasher 1000 is less than or equal to the reference illuminance and the opening angle of the door 1910 is greater than or equal to the threshold angle, and output, when the user is detected in the vicinity of the dishwasher 1000, a notification that the door 1910 is open.

According to an embodiment, when the user is detected in the vicinity of the dishwasher 1000, the dishwasher 1000 may output a notification that the door 1910 is open, by causing a light-emitting module 1630 to emit light.

For example, when the user is detected in the vicinity of the dishwasher 1000, the dishwasher 1000 may output a notification that the door 1910 is open, by turning on the light-emitting module 1630 provided within the dishwasher 1000. In addition, for example, the dishwasher 1000 may increase the output of the light-emitting module 1630 such that the output light becomes brighter as the user approaches the dishwasher 1000. In addition, for example, based on the user approaching the dishwasher 1000, the dishwasher 1000 may output a notification that the door 1910 is open, by emitting a blinking light via the light-emitting module 1630. In addition, for example, the dishwasher 1000 may increase the output of the light-emitting module 1630 as the illuminance outside the dishwasher 1000 decreases.

The light-emitting module 1630 may be arranged on an edge of a side surface of the door 1910, or may be arranged within a washing space of the dishwasher 1000.

According to an embodiment, the dishwasher 1000 may include a proximity sensor 1710 on the right side surface of the door 1910, and another proximity sensor 1710 on the left side surface of the door 1910. In addition, the dishwasher 1000 may store a disabling setting corresponding to one of the proximity sensor 1710 on the right surface of the door 1910 and the proximity sensor 1710 on the left side surface, according to a user setting.

The dishwasher 1000 may activate the proximity sensor 1710 when a reference time period has elapsed after detecting a user manipulation to raise or lower the door 1910, such that a notification that the door 1910 is open is not output when the user is manipulating the dishwasher 1000.

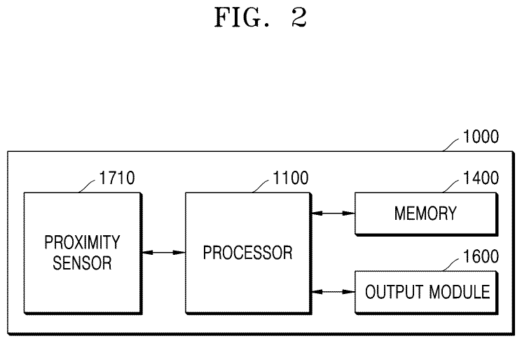

FIG. 2 illustrates a block diagram of a dishwasher according to an embodiment of the present disclosure.

Referring to FIG. 2, the dishwasher 1000 may include a processor 1100, a memory 1400, an output module 1600, and the proximity sensor 1710.

The proximity sensor 1710 may output a detection signal when the user is in the vicinity of the dishwasher 1000. The proximity sensor 1710 may include a time-of-flight (ToF) sensor, a passive infrared (PIR) sensor, but is not limited thereto.

The ToF sensor may output a laser pulse signal and receive a signal reflected from an object. The processor 1100 may determine a distance to the object based on the distance and time of flight of the laser pulse signal output from the ToF sensor.

The PIR sensor may be a sensor configured to detect changes in infrared rays that occur when a person or animal moves. The processor 1100 may detect the user moving in the vicinity of the dishwasher 1000 through the PIR sensor.

The proximity sensor 1710 may be provided in the main body of the dishwasher 1000, and may also be provided in the door of the dishwasher 1000. In addition, the proximity sensor 1710 may be arranged on the right and left sides of the door.

The processor 1100 may activate the proximity sensor 1710 by supplying power to the proximity sensor 1710. In addition, as the proximity sensor 1710 is activated, the processor 1100 may receive a signal output from the proximity sensor 1710, and detect, based on the received output signal, the user moving in the vicinity of the dishwasher 1000.

The output module 1600 may include a light-emitting module (not shown) and an audio output module (not shown).

The light-emitting module (not shown) may include a light-emitting diode (LED) and a lamp, but is not limited thereto. In addition, the light-emitting module (not shown) may be provided inside the dishwasher 1000, and may also be arranged along an outer edge of the door.

The audio output module (not shown) may output a voice or a notification sound to notify that the door is open.

The memory 1400 stores various pieces of information, data, instructions, programs, and the like, necessary for the operation of the dishwasher 1000. For example, the memory 1400 may store identification information about a disabled proximity sensor 1710 among a plurality of proximity sensors 1710. The memory 1400 may include at least one of volatile memory or non-volatile memory, or a combination thereof.

The processor 1100 may generally control the overall operation of the dishwasher 1000. The processor 1100 may execute programs stored in the memory 1400 to control the output module 1600 and the proximity sensor 1710.

Based on whether the door that opens and closes the washing space of the dishwasher 1000 is open, the processor 1100 may determine whether the user is detected in the vicinity of the dishwasher 1000 through the proximity sensor 1710. In addition, based on the user being detected, the processor 1100 may output, through the output module 1600, a notification that the door of the dishwasher 1000 is open.

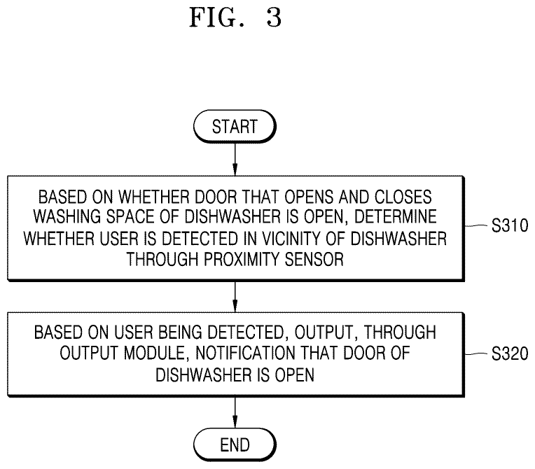

FIG. 3 illustrates a flowchart of a method, performed by a dishwasher, of notifying about a door collision risk, according to an embodiment of the present disclosure.

In operation S310, based on whether the door that opens and closes the washing space of the dishwasher 1000 is open, the dishwasher 1000 may determine whether the user is detected in the vicinity of the dishwasher 1000 through a proximity sensor.

According to an embodiment, based on whether the door that opens and closes the washing space of the dishwasher 1000 is open, the dishwasher 1000 may activate A proximity sensor provided in the dishwasher 1000 by applying power to the proximity sensor. As the proximity sensor is activated, the dishwasher 1000 may receive an output signal from the proximity sensor.

The dishwasher 1000 may determine whether the user is detected in the vicinity of the dishwasher 1000, based on the output signal received from the proximity sensor. In addition, the dishwasher 1000 may also determine a distance from the dishwasher 1000 to the user, based on the output signal received from the proximity sensor.

According to an embodiment, based on whether the door that opens and closes the washing space of the dishwasher 1000 is open, and based on an illuminance outside the dishwasher 1000 detected through an illuminance sensor being less than or equal to a reference illuminance, the dishwasher 1000 may activate the proximity sensor.

According to an embodiment, the dishwasher 1000 may determine, based on an opening angle sensor, whether the door is open by a threshold angle or greater, and based on the door being open by the threshold angle or greater, activate the proximity sensor.

According to an embodiment, the dishwasher 1000 may detect a user manipulation to raise or lower the door, and based on a reference time period elapsing after the user manipulation is detected, activate the proximity sensor.

According to an embodiment, the dishwasher 1000 may receive a user input for setting one of a proximity sensor on the right side surface of the door and a proximity sensor on the left side surface of the door, to be disabled. Based on the received user input, the dishwasher 1000 may cut power to the proximity sensor that is set to be disabled.

In operation S320, based on the user being detected, the dishwasher 1000 may output, through an output module, a notification that the door of the dishwasher 1000 is open.

According to an embodiment, the dishwasher 1000 may output a notification that the door of the dishwasher 1000 is open, by causing the light-emitting module to emit light. In this case, the light-emitting module may be an internal lighting unit inside the washing space, or may be a light-emitting module having a separate light source outside the washing space.

According to an embodiment, the dishwasher 1000 may change the light output pattern of the light-emitting module according to the distance from the dishwasher 1000 to the user. The light output pattern may be determined by a combination of a luminance, a light emission time, a light emission period, or the like.

According to an embodiment, the dishwasher 1000 may output, through an audio output module, a notification sound for notifying that the door of the dishwasher 1000 is open. The notification sound may include a voice including a message notifying about the door open, a warning sound, or the like.

According to an embodiment, the dishwasher 1000 may also adjust the output of the light-emitting module based on a value of an illuminance outside the dishwasher 1000 detected through the illuminance sensor. For example, the dishwasher 1000 may adjust, based on the illuminance value, the output luminance, light emission time, light emission period, or the like of the light-emitting module.

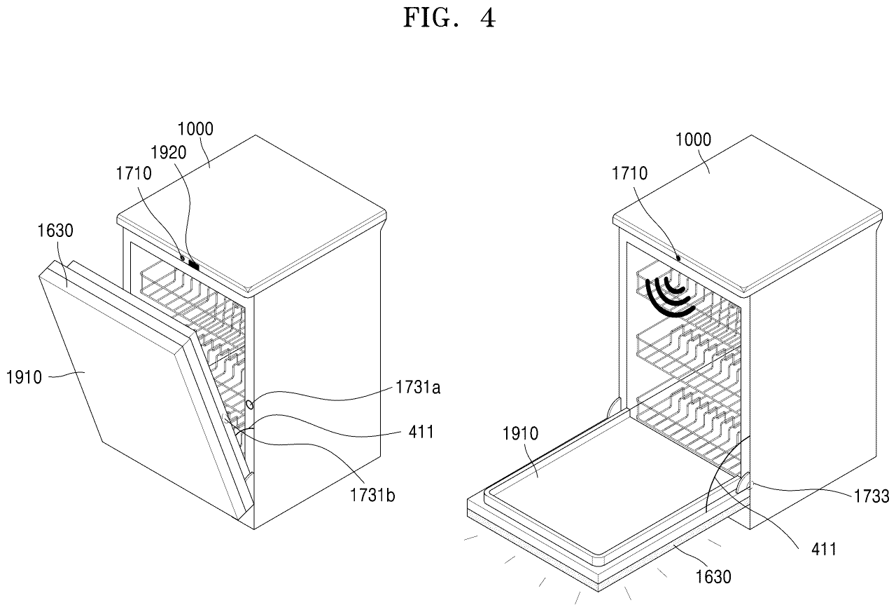

FIG. 4 illustrates a method, performed by a dishwasher, of notifying about a door collision risk, based on an opening angle of a door, according to an embodiment of the present disclosure.

Referring to FIG. 4, the dishwasher 1000 may determine an opening angle of the door 1910, and based on the opening angle of the door 1910 being greater than or equal to a threshold angle, notify about a door collision risk.

According to an embodiment, the dishwasher 1000 may determine whether the door 1910 is open. For example, the dishwasher 1000 may include a door locking device 1920 on a bezel of an upper portion of the main body that comes into contact with the upper end of the door 1910, and may determine whether the door 1910 is open, through a sensor provided in the door locking device 1920.

Based on the door 1910 being open, the dishwasher 1000 may determine the opening angle of the door 1910. For example, the dishwasher 1000 may include a photocoupler 1731 or a Hall angle sensor 1733 as an opening angle sensor of the door 1910, but is not limited thereto.

The Hall angle sensor 1733 may be provided on a hinge of the door 1910 to output an electrical signal proportional to the angle of the hinge. Accordingly, the dishwasher 1000 may determine the angle of the hinge based on the output signal of the Hall angle sensor 1733, and determine the determined angle of the hinge, as an opening angle 411 of the door 1910.

The photocoupler 1731 may include an LED 1731b configured to output light, and a transistor 1731a configured to output, as an electrical signal, an amount of received light. The LED 1731b of the photocoupler 1731 may be provided in an inner bezel portion of the door 1910, and the transistor 1731a may be provided in a bezel portion of the main body that comes into contact with the inner bezel portion of the door 1910. As the opening angle 411 of the door 1910 increases, the amount of light received by the transistor 1731a among light output from the LED 1731b may decrease. Accordingly, based on the opening angle 411 of the door 1910 increasing as the intensity of the output signal decreases, the dishwasher 1000 may determine the opening angle 411 of the door 1910.

According to an embodiment, based on the opening angle of the door 1910 being greater than or equal to the threshold angle, the dishwasher 1000 may activate the proximity sensor 1710. The threshold angle may be, for example, 20 degrees, but is not limited thereto.

For example, in a case in which the threshold angle is 20 degrees, the dishwasher 1000 on the left side of FIG. 4 may determine that the opening angle 411 of the door 1910 is 15 degrees, and may not activate the proximity sensor 1710. Accordingly, even when the user approaches the dishwasher 1000, the dishwasher 1000 may not cause the light-emitting module 1630 to emit light.

In addition, for example, in a case in which the threshold angle is 20 degrees, the dishwasher 1000 on the right side of FIG. 4 may determine that the opening angle 411 of the door 1910 is 90 degrees, and activate the proximity sensor 1710. Accordingly, as the user approaches the dishwasher 1000, the dishwasher 1000 may cause the light-emitting module 1630 to emit light so as to notify about a door collision risk.

FIG. 4 illustrates that a collision risk of the door 1910 may be notified of based on the opening angle of the door 1910 being greater than or equal to the threshold angle, however, according to an embodiment, the dishwasher 1000 may also notify about a collision risk of the door 1910 by activating the proximity sensor 1710, based on the door 1910 being open, regardless of the opening angle of the door 1910.

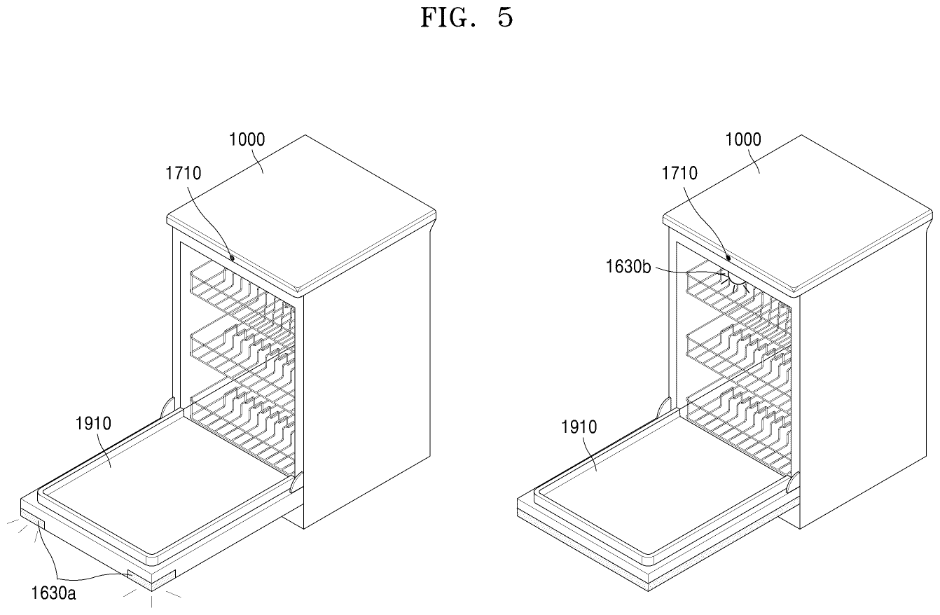

FIG. 5 illustrates a method, performed by a dishwasher, of notifying, through a light-emitting module, about a door collision risk, according to an embodiment of the present disclosure.

Referring to FIG. 5, the dishwasher 1000 may include a light-emitting module 1630a in the door 1910. The dishwasher 1000 may also include a light-emitting module 1630b inside the washing space.

According to an embodiment, the dishwasher 1000 may include a light-emitting module on a side surface of the door 1910.

For example, as illustrated in FIG. 1, an LED bar 1630 may be arranged along a side surface of the door 1910 of the dishwasher 1000. The LED bar 1630 arranged along the side surface of the door 1910 may indicate the outline of the door 1910, and the user may accurately identify the position of the door 1910 based on the LED bar 1630.

In addition, for example, as illustrated on the left side of FIG. 5, the dishwasher 1000 may also include LEDs 1630a in side corner portions of the door 1910. As the LEDs 1630a are provided only in the corner portions of the door 1910, the position of the door 1910 may be indicated and manufacturing cost and power consumption may be reduced.

According to an embodiment, as illustrated on the right side of FIG. 5, the light-emitting module of the dishwasher 1000 may be an internal lighting unit 1630b in the washing space. In this case, the dishwasher 1000 may not include a separate light-emitting module in the door 1910.

Based on the opening angle of the door 1910 being greater than or equal to a reference angle, the dishwasher 1000 may turn on the internal lighting unit 1630b. Accordingly, when the user opens the door 1910 to use the dishwasher 1000, the dishwasher 1000 may turn on the internal lighting unit 1630b.

In addition, when a user manipulation to move the door 1910 is not detected for a reference time period, the dishwasher 1000 may turn off the internal lighting unit 1630b of the dishwasher 1000. For example, the dishwasher 1000 may periodically detect whether the opening angle of the door 1910 changes after the internal lighting unit 1630b is turned on. Based on the opening angle of the door 1910 not changing for the reference time period, the dishwasher 1000 may turn off the internal lighting unit 1630b.

Based on the opening angle of the door 1910 of the dishwasher 1000 being greater than or equal to the threshold angle and the internal lighting unit 1630b being turned off, the dishwasher 1000 may activate the proximity sensor 1710. By activating the proximity sensor 1710, the dishwasher 1000 may start detecting the user in the vicinity of the dishwasher 1000.

According to an embodiment, based on the user being detected through the proximity sensor 1710, the dishwasher 1000 may output light through the light-emitting modules 1630a and 1630b.

According to an embodiment, the dishwasher 1000 may determine a distance from the dishwasher 1000 to the user through the proximity sensor 1710, and based on the determined distance being less than or equal to a reference distance, output light through the light-emitting modules 1630a and 1630b.

According to an embodiment, based on the distance from the dishwasher 1000 to the user being less than or equal to the reference distance, the dishwasher 1000 may emit blinking lights through the light-emitting modules 1630a and 1630b.

According to an embodiment, the dishwasher 1000 may change the output of the light-emitting modules 1630a and 1630b based on the distance from the dishwasher 1000 to the user. For example, the dishwasher 1000 may store output levels of the light-emitting modules 1630a and 1630b according to distances, such that the luminance of light output from the light-emitting modules 1630a and 1630b increases as the distance to the user decreases. Because humans more easily perceive changes in luminance of light than light of constant luminance, the user may more easily recognize that the door 1910 of the dishwasher 1000 is in the user's path.

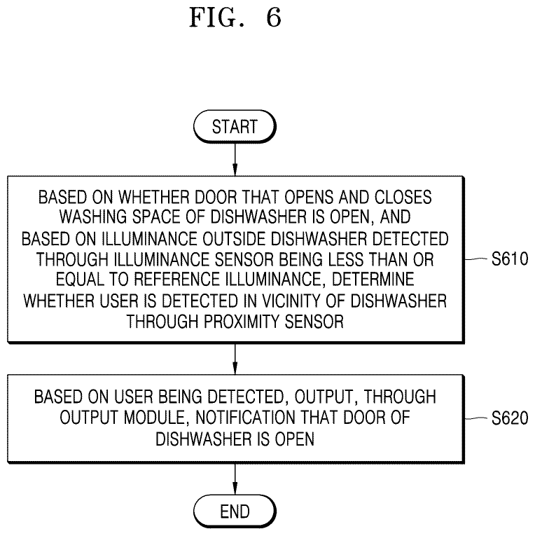

FIG. 6 is a flowchart of a method, performed by a dishwasher, of notifying about a door collision risk, based on an illuminance, according to an embodiment of the present disclosure.

In operation S610, based on whether the door that opens and closes the washing space of the dishwasher 1000 is open, and based on an illuminance outside the dishwasher 1000 detected through an illuminance sensor being less than or equal to a reference illuminance, the dishwasher 1000 may determine whether the user is detected in the vicinity of the dishwasher 1000 through the proximity sensor.

When the door is open and the illuminance outside the dishwasher 1000 is less than the reference illuminance, the dishwasher 1000 may activate the proximity sensor. The dishwasher 1000 may determine whether the user is detected in the vicinity of the dishwasher 1000, based on an output signal received from the proximity sensor.

According to an embodiment, based on the door being open, the dishwasher 1000 may activate the illuminance sensor. According to an embodiment, when the opening angle of the door is greater than or equal to a threshold angle, and the illuminance outside the dishwasher 1000 is less than the reference illuminance, the dishwasher 1000 may activate the proximity sensor.

In operation S620, based on the user being detected, the dishwasher 1000 may output, through an output module, a notification that the door of the dishwasher 1000 is open.

As the proximity sensor is activated, the dishwasher 1000 may detect the user located in the vicinity of the dishwasher 1000, and when the user is detected, output a notification about a door collision risk.

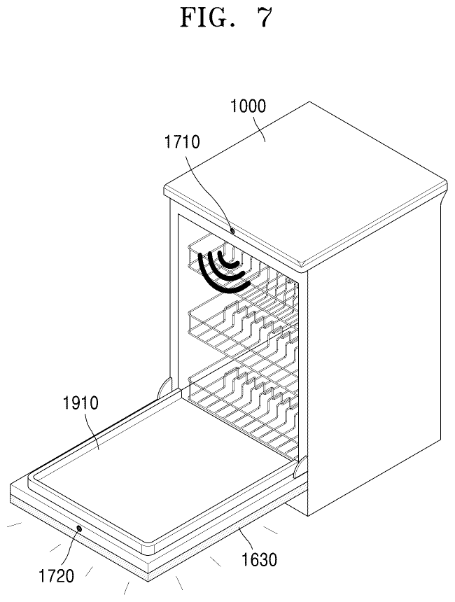

FIG. 7 illustrates a method, performed by a dishwasher, of notifying about a door collision risk, based on an illuminance, according to an embodiment of the present disclosure.

Referring to FIG. 7, the dishwasher 1000 may detect an illuminance outside the dishwasher 1000 through an illuminance sensor 1720, and when the detected illuminance value is less than a reference illuminance, activate the proximity sensor 1710.

The illuminance sensor 1720 may include a photoresistor, a photodiode, and a phototransistor, but is not limited thereto.

As illustrated in FIG. 7, the illuminance sensor 1720 may be arranged on a side surface of the door 1910. According to an embodiment, the illuminance sensor 1720 may be arranged on the upper end of a side surface of the door 1910. In addition, according to an embodiment, the illuminance sensor 1720 may be arranged on a bezel of an upper portion of the main body that come into contact with the upper end of the door 1910. According to an embodiment, based on the door 1910 being open, the dishwasher 1000 may activate the illuminance sensor 1720. As the illuminance sensor 1720 is activated, the illuminance sensor 1720 may detect an illuminance outside the dishwasher 1000.

According to an embodiment, when the door 1910 is open and the illuminance outside the dishwasher 1000 is less than the reference illuminance, the dishwasher 1000 may activate the proximity sensor 1710.

According to an embodiment, when the opening angle of the door 1910 is greater than or equal to a threshold angle, and the illuminance outside the dishwasher 1000 is less than the reference illuminance, the dishwasher 1000 may activate the proximity sensor 1710.

As the proximity sensor 1710 is activated, the dishwasher 1000 may detect the user located in the vicinity of the dishwasher 1000, and when the user is detected, output a notification about a collision risk of the door 1910.

Based on the outside illuminance detected through the illuminance sensor 1720 being greater than or equal to the reference illuminance, the dishwasher 1000 may deactivate the proximity sensor 1710 by cutting power to the proximity sensor 1710. As the proximity sensor 1710 is deactivated, the dishwasher 1000 may not detect the user located in the vicinity of the dishwasher 1000.

According to an embodiment, the dishwasher 1000 may change the intensity of the output of the light-emitting module 1630 based on an illuminance value outside the dishwasher 1000. For example, the dishwasher 1000 may be configured such that the output value of the light-emitting module 1630 increases as the illuminance level decreases. Accordingly, when the detected illuminance value is low, the dishwasher 1000 may increase the output of the light-emitting module 1630 to output brighter light.

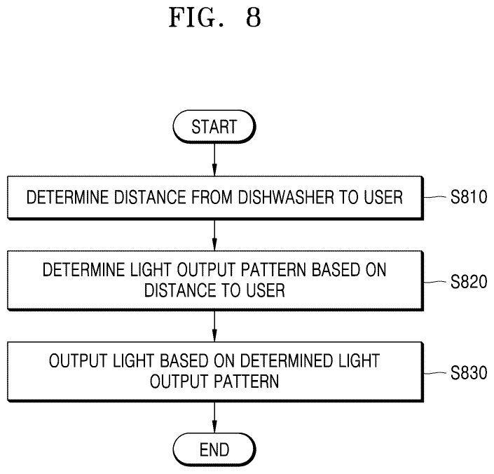

FIG. 8 is a flowchart of a method, performed by a dishwasher, of controlling a light-emitting module, based on a distance to a user, according to an embodiment of the present disclosure.

In operation S810, the dishwasher 1000 may determine a distance from the dishwasher 1000 to the user.

The dishwasher 1000 may detect a distance to the user through at least one of a plurality of proximity sensors in the dishwasher 1000.

For example, the dishwasher 1000 may detect a distance to the user through at least one proximity sensor. For example, the dishwasher 1000 may determine a range of distances to the user based on proximity sensors having different detection ranges.

In operation S820, the dishwasher 1000 may determine a light output pattern based on the distance to the user.

Based on the distance to the user being within a first distance, the dishwasher 1000 may determine the light output pattern as a first pattern. In addition, based on the distance to the user being within a second distance that is less than the first distance, the dishwasher 1000 may determine the light output pattern as a second pattern.

For example, the first pattern may be output of light of a first intensity, and the second pattern may be output of light of a second intensity that is greater than the first intensity. In addition, for example, the first pattern may be output of light of a constant intensity, and the second pattern may be blinking.

In operation S830, the dishwasher 1000 may output light based on the determined light output pattern.

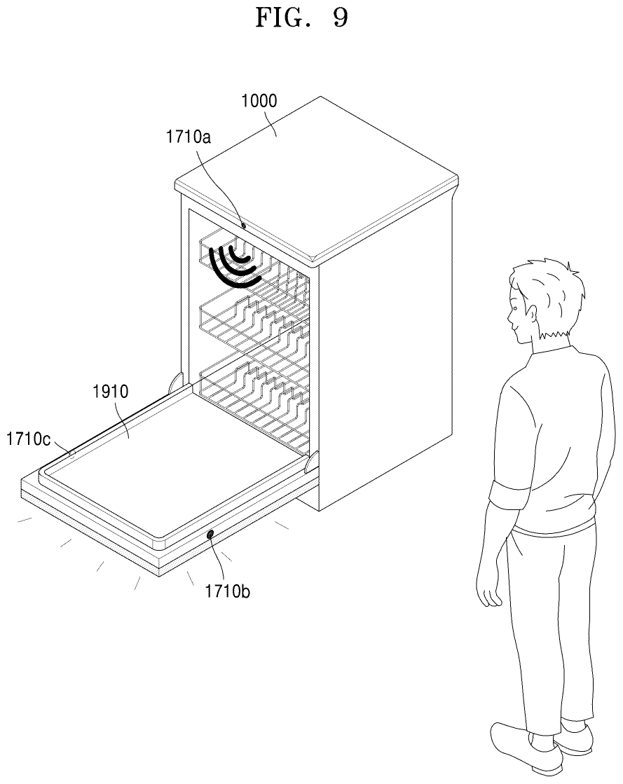

FIG. 9 illustrates a method, performed by a dishwasher, of controlling a light-emitting module, based on a distance to a user, according to an embodiment of the present disclosure.

Referring to FIG. 9, the dishwasher 1000 may include one or more proximity sensors 1710a, 1710b, and 1710c. For example, as illustrated in FIG. 9, the dishwasher 1000 may include the first proximity sensor 1710a at the upper end of the front surface of the main body, and the second proximity sensor 1710b and the third proximity sensor 1710c on opposite side surfaces of the door 1910, respectively.

The dishwasher 1000 may more accurately detect the user located on a side of the door 1910 through the second and third proximity sensors 1710b and 1710c on the opposite side surfaces of the door 1910.

According to an embodiment, based on the user being detected through the first proximity sensor 1710a, the dishwasher 1000 may activate the second proximity sensor 1710b and the third proximity sensor 1710c.

According to an embodiment, the dishwasher 1000 may change the output of the light-emitting module based on a distance to the user. For example, the dishwasher 1000 may output light of a first pattern based on the distance to the user being within a first distance, and output light of a second pattern based on the distance to the user being within a second distance that is less than the first distance.

According to an embodiment, the first to third proximity sensors 1710a to 1710c may be ToF sensors, and the dishwasher 1000 may detect a distance to the user through at least one of the first to third proximity sensors 1710a to 1710c, and control the light-emitting module based on the distance to the user.

In addition, according to an embodiment, the first proximity sensor 1710a and the second and third proximity sensors 1710b and 1710c may be PIR sensors having different detection ranges, and the dishwasher 1000 may determine a range of distances to the user by using the proximity sensors 1710a to 1710c, and control the light-emitting module based on the determined range of distances to the user.

For example, the detection range of the first proximity sensor 1710a on the front surface may be greater than the detection ranges of the second proximity sensor 1710b and the third proximity sensor 1710c on the side surfaces. For example, the detection range of the first proximity sensor 1710a on the front surface may be 3 m, while the detection ranges of the second and third proximity sensors 1710b and 1710c on the side surfaces may be 1.5 m.

Based on the user not being detected through the second or third proximity sensor 1710b or 1710c but being detected through the first proximity sensor 1710a, the dishwasher 1000 may determine that the distance to the user is greater than or equal to 1.5 m but less than 3 m, and output light of the first pattern through the light-emitting module. In addition, based on the user being detected through the first proximity sensor 1710a as well as the second or third proximity sensor 1710b or 1710c, the dishwasher 1000 may determine that the distance to the user is less than 1.5 m, and output light of the second pattern.

According to an embodiment of the present disclosure, the dishwasher 1000 may determine a position of the user by using two or more proximity sensors 1710a, 1710b, and 1710c. For example, when the user is at a position toward which the second proximity sensor 1710b is oriented, the dishwasher 1000 may determine the position of the user based on a first distance measured by the first proximity sensor 1710a and a second distance measured by the second proximity sensor 1710b.

For example, when distances to the user are measured by the first proximity sensor 1710a and the second proximity sensor 1710b, the position of the user is narrowed down to two candidate positions at which the radial range of the first proximity sensor 1710a and the radial range of the second proximity sensor 1710b intersect, and the dishwasher 1000 may determine, as the position of the user, the candidate position toward which the second proximity sensor 1710b is oriented, from among the two candidate positions.

In addition, according to an embodiment of the present disclosure, the dishwasher 1000 may measure distances to the user by using the three proximity sensors 1710a, 1710b, and 1710c, and determine the position of the user by using the three measured distances.

When the dishwasher 1000 obtains the position of the user, the dishwasher 1000 may determine the distance and direction to the user by using information about the position of the user.

According to an embodiment of the present disclosure, the output of light of the first pattern may be output of light of a first intensity, and the output of light of the second pattern may be output of light of a second intensity that is greater than the first intensity. In addition, for example, the output of light of the first pattern may be output of light of a constant intensity, and the output of light of the second pattern may be blinking. Accordingly, by outputting brighter light or outputting a more easily recognizable blinking pattern as the user gets closer to the dishwasher 1000, a door collision risk may be more easily notified of as the user gets closer to the dishwasher 1000.

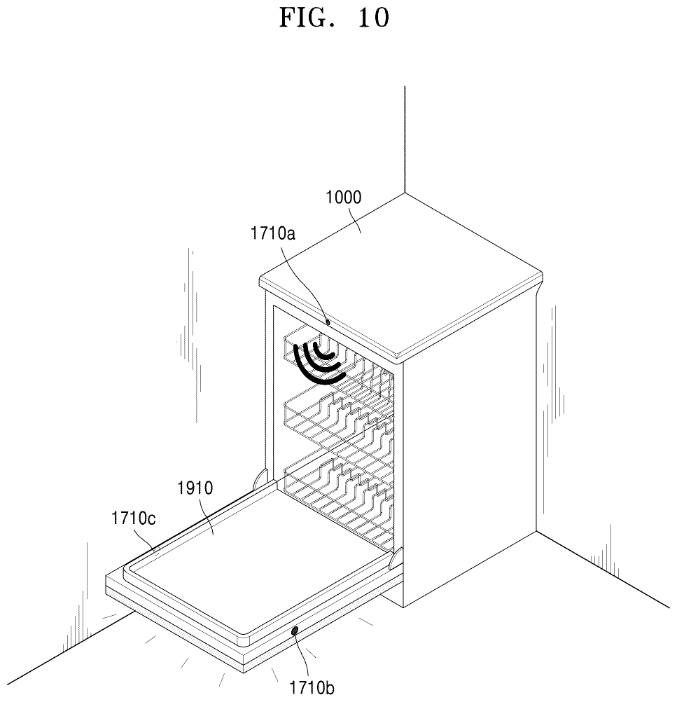

FIG. 10 illustrates a method, performed by a dishwasher, of disabling a proximity sensor according to an installation environment, according to an embodiment of the present disclosure.

Referring to FIG. 10, the dishwasher 1000 may be installed close to a wall. In this case, the dishwasher 1000 may disable the third proximity sensor 1710c that is close to the wall, by cutting power to the third proximity sensor 1710c.

According to an embodiment, the third proximity sensor 1710c close to the wall may be disabled by the user when the dishwasher 1000 is installed. For example, based on a user input for selecting a proximity sensor setting menu, the dishwasher 1000 may display a user interface for changing settings related to proximity sensors. The dishwasher 1000 may receive, through the user interface, a user input for disabling the third proximity sensor 1710c among a plurality of proximity sensors, and may cut power to the third proximity sensor 1710c based on the received user input.

According to an embodiment, the dishwasher 1000 may receive, through the user interface, a user input for setting the disabled third proximity sensor 1710c to be enabled again. Based on the received user input, the dishwasher 1000 may apply power to the third proximity sensor 1710c, and determine whether the user is detected based on a signal output from the third proximity sensor 1710c.

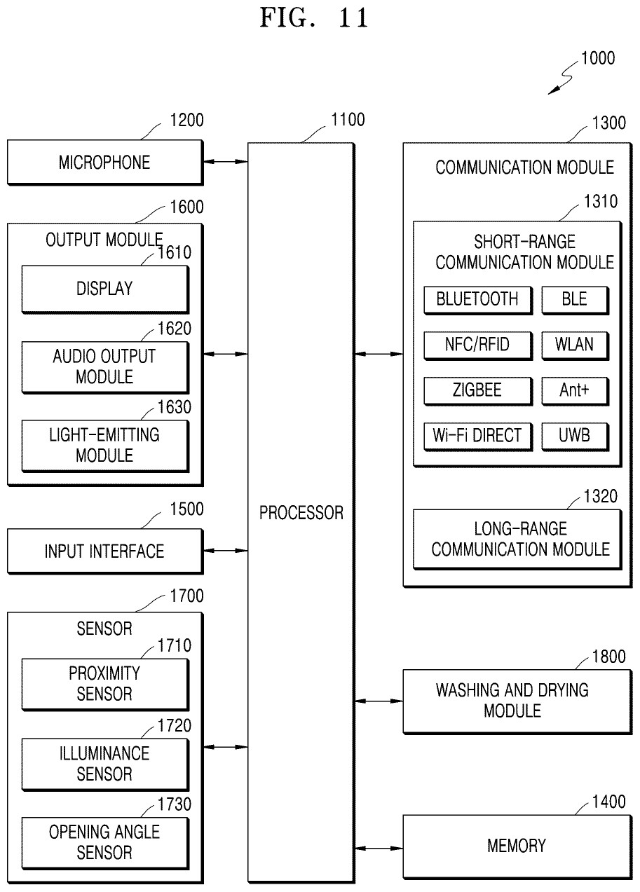

FIG. 11 illustrates a block diagram of a dishwasher according to an embodiment of the present disclosure.

Referring to FIG. 11, the dishwasher 1000 may include the processor 1100, a microphone 1200, a communication module 1300, a memory 1400, an input interface 1500, an output module 1600, a sensor 1700, and a washing and drying module 1800.

Not all of the illustrated components are essential components of the dishwasher 1000. The dishwasher 1000 may be implemented with more components than those illustrated in FIG. 11, or with fewer components than those illustrated in FIG. 11. For example, the dishwasher 1000 may be implemented with the processor 1100, the memory 1400, the output module 1600, the proximity sensor 1710, and the washing and drying module 1800.

The same reference numerals are used for the same components as those illustrated in FIG. 2.

The processor 1100 controls the overall operation of the dishwasher 1000. The processor 1100 may execute a program stored in the memory 1400 to control the components of the dishwasher 1000.

The processor 1100 may include a separate neural processing unit (NPU) configured to perform an operation of a machine learning model. In addition, the processor 1100 may include a central processing unit (CPU), a graphics processing unit (GPU), and the like.

The memory 1400 stores various pieces of information, data, instructions, programs, and the like, necessary for the operation of the dishwasher 1000. The memory 1400 may include at least one of volatile memory or non-volatile memory, or a combination thereof. The memory 1400 may include at least one of a flash memory-type storage medium, a hard disk-type storage medium, a multimedia card micro-type storage medium, card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disc, and an optical disc. In addition, the dishwasher 1000 may operate a web storage or a cloud server (not shown) that performs a storage function on the Internet.

In addition, some of the processor 1100 and the memory 1400 may be implemented as a microcomputer (MICOM) (not shown).

The microphone 1200 may receive a voice command or a voice request from the user. Accordingly, the processor 1100 may control an operation corresponding to the voice command or voice request to be performed. In addition, the microphone 1200 may receive an audio in the vicinity of the dishwasher 1000.

The communication module 1300 may transmit and receive information to and from an external device (not shown) or a server (not shown) according to a protocol under control of the processor 1100. The communication module 1300 may include at least one communication module configured to transmit and receive data to and from the external device (not shown) or the server (not shown), and at least one port.

In addition, the communication module 1300 may perform communication with an external device through at least one wired or wireless communication network. The communication module 1300 may include at least one of a short-range communication module 1310 or a long-range communication module 1320, or a combination thereof. The communication module 1300 may include at least one antenna for wireless communication with other devices.

The short-range communication module 1310 may include at least one communication module (not shown) configured to perform communication according to a communication standard, such as Bluetooth, Wi-Fi, Bluetooth Low Energy (BLE), Near-field communication (NFC)/radio-frequency identification (RFID), Wi-Fi Direct, ultra-wideband (UWB), or Zigbee. In addition, the long-range communication module 1320 may include a communication module (not shown) configured to perform communication through a network for Internet communication. In addition, the long-range communication module 1320 may include a mobile communication unit configured to perform communication according to a communication standard, such as 3^{rd} Generation (3G), 4^{th} Generation (4G), 5^{th} Generation (5G), and/or 6^{th} Generation (6G).

In addition, the communication module 1300 may include a communication module capable of receiving a control command from a remote controller (not shown) at a short distance, for example, an infrared (IR) communication module.

The output module 1600 may include a display 1610, an audio output module 1620, and the light-emitting module 1630, but is not limited thereto.

The display 1610 may output image data processed by an image processor (not shown) through a display panel (not shown) under control of the processor 1100. The display panel (not shown) may include at least one of a liquid-crystal display, a thin-film-transistor liquid-crystal display, an organic light-emitting diode, a flexible display, a three-dimensional (3D) display, and an electrophoretic display.

The audio output module 1620 may output an audio signal to the outside of the dishwasher 1000. The audio output module 1620 may include, for example, a speaker or a receiver. The speaker may be used for general purposes, such as reproducing multimedia or record.

The light-emitting module 1630 may include an LED and a lamp, but is not limited thereto.

The input interface 1500 may receive a user input for controlling the dishwasher 1000. The input interface 1530 may include a key (not shown), a touch screen (not shown), and the like. The input interface 1500 receives a user input and transmits it to the processor 1100.

The input interface 1500 may include, but is not limited to, a user input device including a touch panel for detecting a touch of the user, a button for receiving a push manipulation of the user, a wheel for receiving a rotation manipulation of the user, a keyboard, a dome switch, and the like.

In addition, the input interface 1500 may include a motion sensor (not shown). For example, the motion sensor (not shown) may detect a motion of the user and receive the detected motion as a user input.

The sensor 1700 may include the proximity sensor 1710, the illuminance sensor 1720, and an opening angle sensor 1730.

The proximity sensor 1710 may output a detection signal when the user is in the vicinity of the dishwasher 1000. The proximity sensor 1710 may include a ToF sensor and a PIR sensor, but is not limited thereto. For example, the proximity sensor 1710 may include an ultrasonic sensor and a light-detection-and-ranging (LiDAR) sensor.

The illuminance sensor 1720 may detect an amount of light received by the illuminance sensor 1720. The illuminance sensor 1720 may include a photoresistor, a photodiode, and a phototransistor, but is not limited thereto.

The opening angle sensor 1730 may detect an opening angle of the door. The opening angle sensor 1730 may include a photocoupler and a Hall angle sensor, but is not limited thereto.

The washing and drying module 1800 may wash and dry dishes in the washing space. The washing and drying module 1800 may include a sump unit (not shown), a spraying unit (not shown), and a drying device (not shown), but is not limited thereto.

The washing and drying module 1800 may perform a pre-washing operation, a main washing operation, a rinsing operation, and a drying operation.

The washing and drying module 1800 may perform the pre-washing operation by spraying washing water that is not mixed with a detergent into the washing space before the main operation so as to remove relatively large contaminants from the dishes.

In addition, the washing and drying module 1800 may perform the main washing operation after performing the pre-washing operation. The main washing operation may include a washing water supply operation of supplying washing water to be used for washing to the sump unit (not shown), a washing water spraying operation of spraying washing water mixed with a detergent onto the dishes through the spraying unit (not shown) or heating the washing water and sprays it onto the dishes, and a washing water discharging operation of discharging the washing water stored in the sump unit (not shown) and the spraying unit (not shown).

In addition, the washing and drying module 1800 may perform the rinsing operation after performing the main washing operation. The rinsing operation may include a rinsing water supply operation of supplying rinsing water to be used for rinsing to the sump unit (not shown), a rinsing water spraying operation of spraying the rinsing water stored in the sump unit (not shown) onto the dishes through the spraying unit (not shown) or heating the rinsing water and sprays it onto the dishes, and a rinsing water discharging operation of discharging the rinsing water stored in the sump unit (not shown) and the spraying unit (not shown).

The washing and drying module 1800 may perform the drying operation after performing the rinsing operation.

The drying operation may be an operation for drying the dishes by circulating air inside the washing space and supplying hot air into the washing space by using the drying device (not shown).

The processor 1100 may open the door at a preset angle (e.g., 15 degrees) after the drying operation is terminated.

According to an embodiment, at least one processor 1100 may determine whether the door that opens and closes the washing space of the dishwasher 1000 is open. The at least one processor 1100 may activate the proximity sensor 1710 based on whether the door is open. The at least one processor 1100 may determine whether the user is detected in the vicinity of the dishwasher 1000 through the proximity sensor 1710. Based on the user being detected, the at least one processor 1100 may output, through the output module 1600, a notification that the door of the dishwasher 1000 is open.

The at least one processor 1100 may determine whether an illuminance outside the dishwasher 1000 detected through the illuminance sensor 1720 is less than or equal to a reference illuminance.

Based on whether the door that opens and closes the washing space of the dishwasher 1000 is open, and based on the illuminance outside the dishwasher 1000 detected through the illuminance sensor 1720 being less than or equal to the reference illuminance, the at least one processor 1100 may determine whether the user is detected in the vicinity of the dishwasher 1000 through the proximity sensor 1710.

The at least one processor 1100 may output a notification that the door of the dishwasher 1000 is open, by causing the light-emitting module 1630 to emit light.

The at least one processor 1100 may output, through the audio output module 1620, a notification sound for notifying that the door of the dishwasher 1000 is open.

The at least one processor 1100 may determine, through the opening angle sensor 1730, whether the door is open by a threshold angle or greater. Based on whether the door is open by the threshold angle or greater, the at least one processor 1100 may determine whether the user is detected in the vicinity of the dishwasher 1000 through the proximity sensor 1710.

The at least one processor 1100 may change the light output pattern of the light-emitting module 1630 according to a distance from the dishwasher 1000 to the user.

The at least one processor 1100 may receive a user input for setting one of the proximity sensor 1710 on the right side surface of the door and the proximity sensor 1710 on the left side surface of the door, to be disabled. Based on the user input for setting one of the proximity sensor 1710 on the right side surface of the door and the proximity sensor 1710 on the left side surface to be disabled, the at least one processor 1100 may apply power only to the proximity sensor 1710 that is not set to be disabled, and may cut power to the proximity sensor 1710 that is set to be disabled.

Based on an illuminance value outside the dishwasher 1000 detected through the illuminance sensor 1720, the at least one processor 1100 may change a method of outputting a notification through the output module 1600.

The at least one processor 1100 may detect a user manipulation to raise or lower the door. Based on a reference time period elapsing after the user manipulation to raise or lower the door is detected, the at least one processor 1100 may detect whether the user is detected in the vicinity of the dishwasher 1000 through the proximity sensor 1710.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

1. A dishwasher comprising:
At least one proximity sensor;
an output module;
at least one memory storing one or more instructions; and
at least one processor configured to execute the one or more instructions stored in the at least one memory to:
determine whether a user is in proximity to the dishwasher using the at least one proximity sensor, based on a door that opens and closes a washing space of the dishwasher being open, and
control, based on determining whether the user is in proximity, the output module to output a notification corresponding to the door being open.

2. The dishwasher of claim 1, wherein the dishwasher further comprises at least one illuminance sensor, and
the at least one processor is further configured to execute the one or more instructions stored in the at least one memory to:
identify whether the user is in proximity to the dishwasher using the at least one proximity sensor based on the door of the dishwasher being open, and based on an illuminance value outside the dishwasher detected through the at least one illuminance sensor being less than or equal to a reference illuminance.

3. The dishwasher of claim 1, wherein the output module comprises a light-emitting module, and
the at least one processor is further configured to execute the one or more instructions stored in the at least one memory to cause the light-emitting module to emit light as the notification.

4. The dishwasher of claim 1, wherein the output module comprises an audio output module, and
the at least one processor is further configured to execute the one or more instructions stored in the at least one memory to, cause the audio output module to output a sound as the notification.

5. The dishwasher of claim 1, wherein the at least one processor is further configured to execute the one or more instructions stored in the at least one memory to, based on the door being open at a threshold angle or greater, identify whether the user is in proximity to the dishwasher using the at least one proximity sensor.

6. The dishwasher of claim 3, wherein the at least one processor is further configured to execute the one or more instructions stored in the at least one memory to change a light output pattern of the light-emitting module based on a distance from the dishwasher to the user.

7. The dishwasher of claim 1, wherein the at least one processor is further configured to execute the one or more instructions stored in the at least one memory to, based on a user input for setting one of the at least one proximity sensor to be disabled, cut power to the one that is set to be disabled.

8. The dishwasher of claim 1, wherein the at least one processor is further configured to execute the one or more instructions stored in the at least one memory to, based on an illuminance value outside the dishwasher detected through the at least one illuminance sensor, change a method of outputting the notification through the output module.

9. The dishwasher of claim 3, wherein the light-emitting module is arranged on a side surface of the door.

10. The dishwasher of claim 1, wherein the at least one processor is further configured to execute the one or more instructions stored in the at least one memory to detect a user manipulation of the dishwasher, and based on a reference time period elapsing after the user manipulation is detected, detect whether the user is in proximity to the dishwasher using the proximity sensor.

11. A method, performed by a dishwasher, of providing a notification, the method comprising:
identifying whether a user is in proximity to the dishwasher using at least one proximity sensor, based on a door that opens and closes a washing space of the dishwasher being open; and
outputting a notification corresponding to the door of the dishwasher being open, based on determining whether the user is in proximity.

12. The method of claim 11, wherein the identifying whether the user is in proximity to the dishwasher comprises, based on the identifying the door of the dishwasher is open, and based on an illuminance outside the dishwasher being less than or equal to a reference illuminance, identifying whether the user is in proximity to the dishwasher.

13. The method of claim 11, wherein the outputting of the notification comprises emitting light.

14. The method of claim 11, wherein the outputting of the notification comprises outputting a sound.

15. The method of claim 11, wherein the identifying whether the user is in proximity to the dishwasher comprises, based on whether the door is open at a threshold angle or greater, identifying whether the user is in proximity to the dishwasher.

16. The method of claim 13, wherein the emitting light comprises changing a light output pattern based on to a distance from the dishwasher to the user.

17. The method of claim 11, further comprising:
based on a user input for setting one of the at least one proximity sensor to be disabled, cutting power to the one that is set to be disabled.

18. The method of claim 11, wherein a method of outputting the notification is based on an illuminance value outside the dishwasher.

19. The method of claim 11, wherein the light is emitted from a side of the door.

20. The method of claim 11, wherein the identifying whether the user is in proximity to the dishwasher comprises, detecting a user manipulation of the dishwasher, and based on a reference time period elapsing after the user manipulation is detected, detecting whether the user is in proximity to the dishwasher.
